(19) United States
(12) Patent Application Publication
(10) Pub. No.: US 2026/0370621 A1
(43) Pub. Date: Nov. 19, 2026

(54) ALIGNING TOPIC DIGESTS FOR SEQUENCES OF MESSAGES TO INDIVIDUAL USERS

(71) Applicant: MICROSOFT TECHNOLOGY LICENSING, LLC, Redmond, WA (US)

(72) Inventors: Cristina Elena DAESCU, Seattle, WA (US); Yuchen LI, Redmond, WA (US); Partha Prateem TRIPATHY, Hoboken, NJ (US)

(21) Appl. No.: 19/206,561

(22) Filed: May 13, 2025

(51) Int. Cl. H04L 51/216; G06F 9/451

(52) U.S. Cl. CPC H04L 51/216; G06F 9/451

(57) ABSTRACT

The techniques presented herein are directed to a system for aligning topic digests of a sequence of messages to an individual user. In various examples, software solutions that face large, heterogenous user populations often require system designers to decide between maintaining full control of the software or aiming to satisfy all users. That is, systems that do not utilize the techniques discussed herein may be too rigid to accommodate the diverse use cases of a large, heterogenous user population or, conversely, contend with the technical infeasibility of anticipating the needs of thousands or even millions of users. To address this technical challenge, the present techniques provide a language model-based approach that consumes sequences of messages (e.g., emails), outputs a topic digest organizing the sequence of messages into individual topics, and aligns successive iterations of the topic digest to user feedback regarding previous topic digests to provide a customizable user experience.

### BACKGROUND

Recent times have seen the proliferation of generative artificial intelligence-based productivity tools. Examples include tools for combing through massive amounts of data for compiling analytics, generating text content for message answering, and implementing automated software testing suites. One common use case is summarizing content such as a text document, an online meeting transcript, and the like. For instance, a user that is overwhelmed with unread emails can invoke an artificial intelligence model to analyze their inbox and generate an organized summary. In another example, rather than reading a long text document, a user can upload the text document to an artificial intelligence tool and receive a summary laying out the main topics and/or arguments.

However, software solutions that face large, heterogenous user populations (e.g., machine learning-based productivity tools) often require system designers to decide between maintaining full control of the software or aiming to satisfy all users. That is, a thoroughly designed and implemented software solution may be too rigid to accommodate the diverse use cases of a large, heterogenous user population. Conversely, enabling user customization and/or personalization to satisfy the needs of thousands or even millions of users is often technically infeasible. For example, software applications that implement personalization features may be restricted to training and/or running machine learning models on private, personal data located on personal computing devices (e.g., laptops, smartphones, tablets). Due to the wildly variable computational capacity of these personal computing devices, machine learning models that enable personalization features may lack the power to function effectively and/or efficiently.

It is with respect to these and other considerations that the disclosure made herein is presented.

### SUMMARY

The techniques presented herein are directed to a system for aligning topic digests of a sequence of messages to an individual user. As mentioned above, software solutions that face large, heterogenous user populations often require system designers to decide between maintaining full control of the software or aiming to satisfy all users. That is, systems that do not utilize the techniques discussed herein may be too rigid to accommodate the diverse use cases of a large, heterogenous user population or, conversely, contend with the technical infeasibility of anticipating the needs of thousands or even millions of users.

To address this technical challenge, the present system and method provides mechanisms that consume sequences of messages (e.g., emails, chat messages) and utilizes a language model-based approach to output a topic digest and align successive iterations of the topic digest to user feedback regarding previous iterations of the topic digests. Within the context of the present disclosure, a topic digest is a collection of one or more topics that group individual messages based on shared semantic content (e.g., a “marketing” topic, a “team updates” topic). In various examples, the system is not initialized (e.g., biased) with respect to any particular topics. That is, the first time the system generates a topic digest for a first sequence of messages it is done without prior knowledge of the user's behaviors and/or tendencies.

For instance, the user may be logging into a new email account and/or a new message application for the first time. Accordingly, the system identifies, via execution of a computational model (e.g., a large language model, a small language model, a multimodal language model) an initial plurality of topics based on the semantic content of the first sequence of messages. Stated another way, the computational model can analyze the text and/or image content of the first sequence of messages to identify the various topics present in the first sequence of messages as a whole. The system can then sort each message of the first sequence into individual topics to produce an initial iteration of the topic digest.

In a specific example, consider the inbox of an email application in which messages can arrive from any number of senders and include any manner of semantic content (e.g., junk mail, advertisements, work items). The system can be invoked to process all currently unread messages to identify various topics for categorizing the unread messages (e.g., a “junk mail” topic, an “advertisements” topic, a “work items” topic). Subsequently, the system sorts each of the unread messages into the identified topics to form the topic digest. Accordingly, the system modifies the user interface of the email application to display a rendering of the topic digest presenting the sequence of unread messages sorted into the various topics. In various examples, each topic includes a title, keywords, a summary of the constituent messages, and citations to individual messages.

The user can then view and interact with the topic digest in various ways. In one example, the user expands a first topic (e.g., a “work items” topic) to read its summary and read individual messages by clicking on citations. In another example, the user bulk views a second topic (e.g., an “advertisements” topic) and bulk deletes the messages therein without reading them. In this way, the user implicitly demonstrates their preferences with respect to the first topic and the second topic through their interaction with the topic digest. In addition, the user can provide explicit feedback to express their interest in specific topics (e.g., an “Favorites” button). The system can record these interactions for use in generating subsequent iterations of the topic digest.

At a later time, the system can be invoked to process a second sequence of messages to generate a new iteration of the topic digest. However, rather than identify topics from only the semantic content of the second sequence of messages, the system can utilize a topic initialization input derived from previous user interactions to bias the selection of topics towards those the user expressed an interest in. In various examples, biasing the topic selection can include modifying the granularities of various topics (e.g., breaking up a “work items” topic into a “team updates” topic and a “bug reports” topic), prioritizing specific topics, suggesting actions for other topics (including a “consider deleting” tag in conjunction with an “advertisements” topic). In this way, this updated plurality of topics aligns more closely with the user's demonstrated preferences in relation to the previous iteration of the topic digest.

As in the above example, the system sorts the individual messages of the second sequence into the updated plurality of topics to generate the new iteration of the topic digest. Likewise, the system modifies the user interface to display a rendering of the new iteration of the topic digest presenting the second sequence of messages sorted into the updated plurality of topics. As such, this process forms a feedback loop that accumulates user interactions over time to gradually form a detailed profile of the user's preferences with respect to the information presented in successive iterations of the topic digest. In this way, the system conforms to the user's explicit preferences (e.g., “favorite” topics) as well as their behaviors and tendencies as they interact with various iterations of the topic digest.

Accordingly, in one example of the technical benefit of the present disclosure, the user does not have to read and sort incoming messages as they arrive. Rather, the user can focus on the latest updates on their preferred topics first. Since all incoming messages are included in the topic digest, the user can eventually reach topics of low importance and cover all emails. In this way, the user can reduce the time spent going through messages thereby improving system efficiency. Consequently, the user can spend more time going about more engaging and/or productive activities thereby enhancing the user experience.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for aligning topic digests of a sequence of messages to an individual user.

FIG. 2 illustrates aspects of a preprocessor for producing an initialization input to a computational model for generating topic digests.

FIG. 3A illustrates a warm-up process for initializing a computational model for generating topic digests using supplementary data.

FIG. 3B illustrates a process for selecting topics using a topic relevancy competition.

FIG. 4A illustrates an example user interface for viewing and/or interacting with a topic digest displaying a plurality of topics.

FIG. 4B illustrates an example user interface for viewing and/or interacting with a topic digest displaying an expanded topic.

FIG. 5 is a flow diagram showing aspects of a process for aligning topic digests to an individual user.

FIG. 6 is a computer architecture diagram illustrating an illustrative computer hardware and software architecture for a computing system capable of implementing aspects of the techniques and technologies presented herein.

### DETAILED DESCRIPTION

The techniques presented herein are directed to a system for aligning topic digests of a sequence of messages to an individual user. As mentioned above, software solutions that face large, heterogenous user populations often require system designers to decide between maintaining full control of the software or aiming to satisfy all users. That is, systems that do not utilize the techniques discussed herein may be too rigid to accommodate the diverse use cases of a large, heterogenous user population or, conversely, contend with the technical infeasibility of anticipating the needs of thousands or even millions of users.

To address this technical challenge, the present system and method provides mechanisms that consume sequences of messages (e.g., emails, chat messages) and utilizes a language model-based approach to output a topic digest and align successive iterations of the topic digest to user feedback regarding previous topic digests. Within the context of the present disclosure, a topic digest is a collection of one or more topics that group individual messages based on shared semantic content (e.g., a “marketing” topic, a “team updates” topic). Language models such as large language models (LLMs), small language models (SLMs), and the like have emerged as a low-latency personalization solution especially with respect to natural language (e.g., English) due to their training on large amounts of text data, image data, and/or other data to learn statistical relationships between individual tokens (e.g., words, characters, phrases).

For instance, the language model can be trained to predict tokens in sequences of textual training data. Consequently, the language model achieves predictive capability with respect to vague and/or typically nebulous aspects inherent to natural language such as syntax, semantics, and ontologies. Subsequently, when employed in inference mode, the output of the language model can include new sequences of text that the model generates (e.g., a recap summary output). In this way, language models are especially well-suited for analyzing the complex and often nebulous relationships inherent in human-readable text.

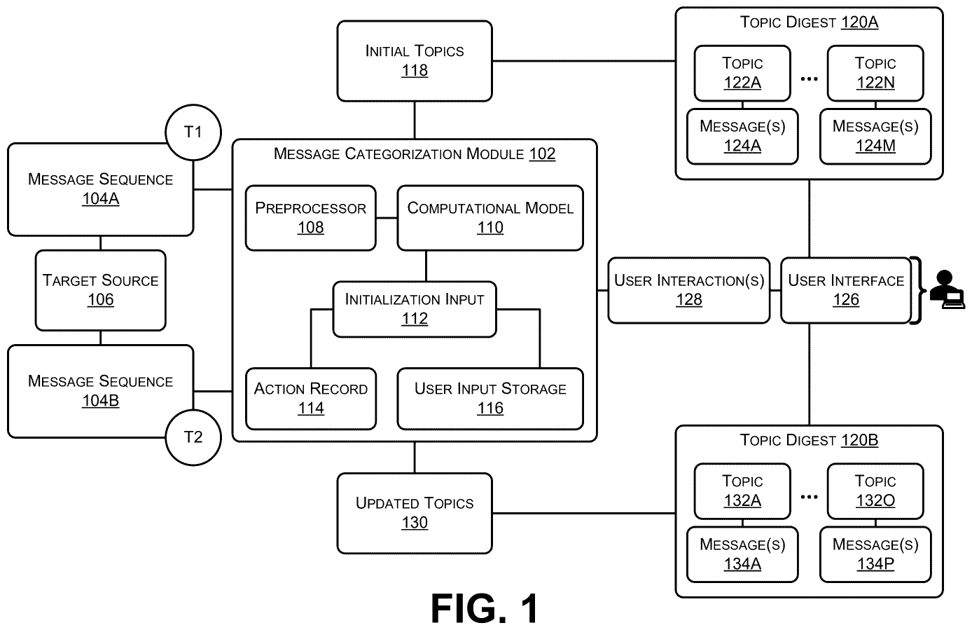

Various examples, scenarios, and aspects related to the techniques are described below with respect to FIGS. 1-6.

FIG. 1 illustrates a system in which a message categorization module 102 generates a topic digest from a message sequence 104A comprising a plurality of messages that are ordered with respect to time. Examples of a message sequence 104A include an email inbox in which incoming messages are ordered chronologically, a messaging software application (e.g., text messages on a smartphone, an online chatroom), and the like. More specifically, the message sequence 104A can be a collection of currently unread messages (e.g., unread emails, unread text messages). As shown, the message categorization module 102 receives the message sequence 104A during a first timeframe T1 from a target source 106. Generally described, the target source 106 is a location within a messaging software application that is targeted for organization via topic digests. In various examples, the target source 106 is a location in which the user receives incoming messages (e.g., an inbox in an email client).

In response, the message categorization module 102 utilizes a preprocessor 108 to organize the message sequence 104A prior to analysis. As will be elaborated upon below, the preprocessor 108 can perform a preliminary analysis on the message sequence 104A to rearrange the message sequence 104A to improve performance during analysis by a computational model 110. For example, consider a user's work email inbox in which messages can arrive from any number of senders and include any manner of semantic content (e.g., junk mail, advertisements, work items). In this example, the preprocessor 108 can group messages based on social distance with reference to the sender and/or receivers of each individual message. Consequently, messages within the same social group are more likely to share a similar semantic context. For instance, emails from a user's coworker most likely bare relevance to each other (e.g., work items). In this way, the preprocessor 108 can improve the efficiency of the computational model 110 by maintaining semantic context across a plurality of messages. This is especially true in systems where the computational model 110 is a language model that oftentimes experience performance benefits from minimizing sudden shifts in semantic context.

In addition to receiving the preprocessed message sequence 104A, the computational model 110 can be configured with an initialization input 112 that is derived from an action record 114 and a user input storage 116. In various examples, the initialization input 112 is included in an input instruction to the computational model 110 (e.g., a prompt). In general, a prompt refers to any input provided to the computational model 110 that causes the computational model 110 to generate an output. A prompt can be provided in various modalities, such as text, an image, audio, video, and so forth. In various examples, a prompt is input to the computational model 110 as a natural language command (e.g., “Create topic digests of the following messages,” “Scavenge for relevant messages”). Even more generally, the computational model 110 can be interpreted as a compiler and runtime environment for a prompt wherein the prompt assumes the role of a model that does not need to be trained to consume input text to output target text.

Within the context of the present disclosure, the action record 114 is a record of user behaviors with respect to the topic digest system that implicitly express the user's preferences with respect to various topics (e.g., deleting messages, reading messages, replying to messages). For instance, if a user deletes an advertising message without reading it, the action record 114 records the deletion action as an expression of the user's preferences regarding advertising messages (e.g., the user does not care and/or does not wish to see advertising messages). Conversely, the user input storage 116 is a record of the user's explicit feedback with respect to various topics. As will be discussed below, the system can provide user interfaces mechanisms for the user to explicitly state whether a given topic was accurate and/or helpful as well as selecting various topics as “Favorites.”

However, consider an example in which the action record 114 and/or the user input storage 116 are empty at the timeframe T1. That is, the timeframe T1 may be the first time the user has interacted with the system of FIG. 1. Consequently, the message categorization module 102 does not have any prior knowledge of the user's preferences and/or tendencies with which to bias the computational model 110 for customization. As such, the first execution of the computational model 110 is configured to identify a plurality of initial topics 118 based on the semantic content of the message sequence 104A without influence from the user's known interests and/or tendencies (of which there are none at the timeframe T1). That is, the initial topics 118 are a straightforward mapping of the semantic content that is conveyed by the message sequence 104A (e.g., a cold start).

Accordingly, the initial topics 118 are compiled into a first iteration of the topic digest 120A in which each individual message of the message sequence 104A is sorted into a topic 122A-122N from the initial topics 118. In various examples, this sorting is performed by the computational model 110 via a relevance scavenging approach in which an individual message is matched to a topic 122A based on its semantic content. For example, one topic 122A can be a “Work Items” topic containing messages 124A from the sequence of messages 104A that convey semantic content relating to work tasks. In another example, a topic 122N can be a “Marketing” topic containing messages 124N from the sequence of messages 104A that convey semantic content promoting topics and/or services from external senders. In the present example, the individual topics 122A-122N of the initial topics 118 may be broad (e.g., coarse granularity) owing to the lack of available information in the action record 114 and/or the user input storage 116 during the timeframe T1.

After compiling the topic digest 120A, the message categorization module 102 can modify a user interface 126 of the messaging software application to display a rendering of the topic digest 120A. That is, the user interface 126 presents the first message sequence 104A sorted into the topics 122A-122N of the initial topics 118. In addition, the rendering of the topic digest 120A can include citations to individual messages 124A-124M that the user can select (e.g., click, tap, voice command) to open and view. Accordingly, the user can scroll through the plurality of initial topics 118, expand individual topics 122A-122N of the initial topics 118, view specific messages, delete messages, reply to messages, and so forth.

The message categorization module 102 can then record user interactions 128 with the topic digest 120A via the action record 114 and/or the user input storage 116. As mentioned above, the action record 114 stores user actions that implicitly demonstrate the user's preferences with respect to the individual topics 122A-122N. For instance, in one user interaction 128 the user may bulk delete the “Marketing” topic 122N without expanding the topic 122N and/or reading the individual messages 124M. This user interaction 128 may imply that the user does not prioritize and/or wish to see marketing messages and is stored in the action record 114. In another user interaction 128, the user may “favorite” a “Work Items” topic 122A to explicitly express that they prioritize messages relating to the “Work Items” topic 122A. This user interaction 128 is stored in the user input storage 116.

Then, at a subsequent timeframe T2, the message categorization module 102 may receive a second message sequence 104B from the target source 106 (e.g., unread messages from the email inbox). In various examples, the second message sequence 104B is a continuation of the first message sequence 140A. That is, the first message sequence 104A and the second message sequence 104B may be a continuous stream of messages that is partitioned by executions of the message categorization module 102 at various points in time. As in the above example, the second message sequence 104B is preliminarily analyzed and/or rearranged by the preprocessor 108 prior to analysis by a second execution of the computational model 110.

In contrast to the previous example however, the message categorization module 102 utilizes an initialization input 112 derived from the user interactions 128 with the first iteration of the topic digest 120A to bias the computational model 110. In various examples, the initialization input 112 is generated based on user interactions 128 with one or more past iterations of the topic digest 120A recorded in the action record 114 and/or the user input storage 116. For example, the action record 114 may indicate that the user bulk deleted a “Marketing” topic 122N without expanding the topic 122N and/or reading the individual messages 124M in the topic digest 120A. Conversely, the user input storage 116 may indicate that the user “favorited” a “Work Items” topic 122A to explicitly express that they prioritize messages relating to the “Work Items” topic 122A.

Accordingly, the initialization input 112 can bias the computational model 110 in various ways with respect to one or more of the topics 122A-122N. For example, in response to the user “favoriting” the “Work Items” topic 122A, the initialization input 112 may cause the computational model 110 to prioritize the inclusion of the “Work Items” topic 122A in an updated plurality of topics 130. Moreover, if the user has explicitly expressed interest in the “Work Items” topic 122A, the initialization input 112 may further cause the computation model 110 to adjust the granularity relevant topics in the updated topics 130. For instance, rather than a broad “Work Items” topic 122A, as was included in the initial topics 118, the updated topics 130 may divide the “Work Items” topic 122A into a “Team Updates” topic, a “Bug Reports” topic, and so forth. In another example, the initialization input 112 may cause the computational model 110 to associate certain topics with specific actions per the action record 114. For instance, returning to the aforementioned “Marketing” topic 122N, the initialization input 112 can cause the computational model 110 to group the “Marketing” topic 122N with similar topics under a broad “Consider Deleting” category. Moreover, in response to the user's tendency to bulk delete messages in the “Marketing” topic 122N, the granularity of the “Marketing” topic 122N can remain broad as the user is unlikely to care whether a marketing message is promoting software tools or handbags.

Accordingly, the updated topics 130 can be compiled into a second iteration of the topic digest 120B in which the selection of the individual topics 132A-132O is biased based the user interactions 128 with one or more past iterations of the topic digest 120A. In this way, the updated topics 130 more closely adheres to the user's explicit preferences and/or their behavioral tendencies in relation to the initial topics 118. That is, at user interactions 128 accumulate over time, the initialization input 112 gradually conforms to the individual user's specific context.

Furthermore, the updated topics 130 can be ranked based on a frequency of user interaction with each topic 132A-132O of the updated topics 130 derived from the user interaction 128 with the first iteration of the topic digest 120A. For example, the “Work Items” topic 122A that the user favorited as well as topics deriving from it (e.g., the “Team Updates” topic, the “Bug Reports” topic) may be ranked above the “Marketing” topic 122N which the user bulk deleted. Accordingly, this ranking can cause the “Team Updates” topic to be presented as the first topic 132A in the topic digest 120B whereas the “Marketing” topic 122N is presented as the last topic 132O in the topic digest 120B. After selecting and/or ranking the updated topics 130, the computational model 110 sorts each message of the second message sequence 104B into the topics 132A-132O of the 120B. For instance, due to the refined granularity of the “Team Updates” topic, the topic 132A can include messages 134A with a finer degree of specificity. Conversely, the computational model 110 maintains the broad granularity of the “Marketing” topic, resulting in a topic 132O that includes messages 134P that generally relate to promoting products and/or services. In this way, the message categorization module 102 iteratively learns the individual user's preferences based on both implicit and explicit user inputs to provide customizable user experience that satisfies the diverse use cases of thousands or even millions of users while retaining a well-defined architecture that benefits system designers and/or engineers.

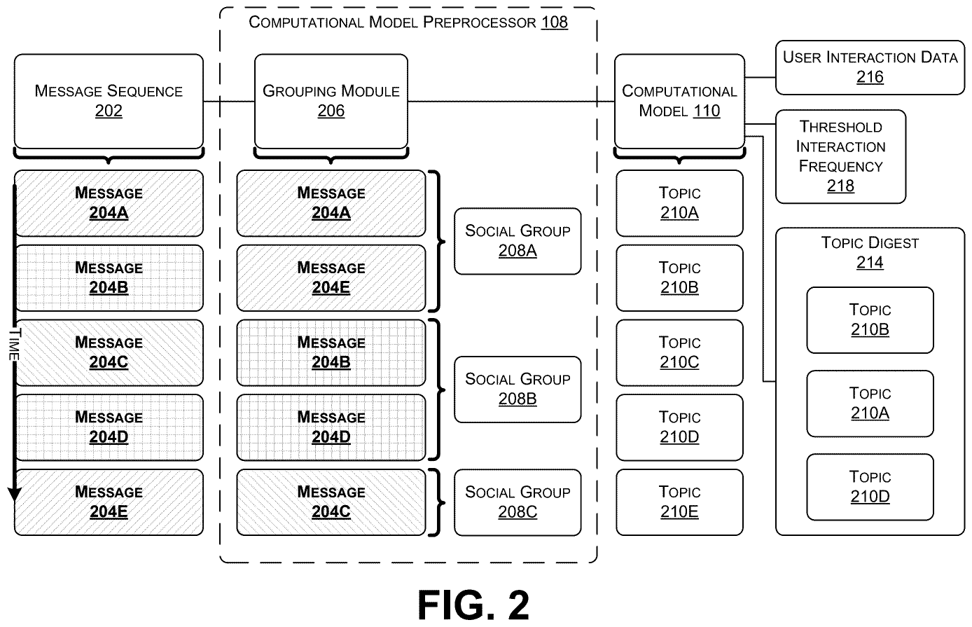

Turning now to FIG. 2, additional technical details of the computational model preprocessor 108 for preprocessing a message sequence 202 based on a sender and a receiver of each message are shown and described. As mentioned above, preprocessing the message sequence 202 in specific ways can improve the efficiency of downstream analysis. For instance, language models can be sensitive to the ordering of input information owing to submodules with parameters tuned on sequences of input that are replicated throughout their architecture (e.g., transformers, attention mechanisms, embeddings). As such, maintaining semantic continuity where possible can improve model performance, efficiency, and/or latency.

As shown, the message sequence 202 comprises a plurality of messages 204A-204E that are ordered with respect to time (e.g., a time of receipt). In a specific example, the message sequence 202 is a collection of currently unread emails in a user's work inbox. As such, the messages 204A-204E can originate from disparate senders and contain wildly varying semantic content. For instance, the message 204A may be an update from a colleague regarding ongoing work while the message 204C is a marketing promotion from an external organization.

Accordingly, the computational model preprocessor 108 utilizes a grouping module 206 to rearrange the message sequence 202 to sort the messages 204A-204E by social group 208A-208C. As shown by the pattern fill on each message 204A-204E, messages with the same pattern fill belong to the same social group 208. For instance, the messages 204A and 204E may originate from senders that belong to the same team as the user. That is, the messages 204A and 204E have the same social distance to the user. Consequently, the messages 204A and 204E can be said to belong to the same social group 208A and are thus represented in FIG. 2 with the same diagonal pattern fill.

Moreover, the ordering of the social groups 208A-208C can be based on a social distance relative to the user rather than chronologically. For example, consider a scenario in which the messages 204B and 204D belong to a social group 208B that is of greater social distance to its recipients in relation to the social group 208A. That is, where the messages 204A and 204E originate from senders and receivers that belong to the same team, the messages 204B and 204D originate from senders that are in different departments within the same organization from their receivers. Accordingly, the message 204C of the social group 208C is of an even greater social distance (e.g., an external sender) and is ordered last among the message sequence 202 despite having arrived prior to the messages 204D and 204E. In this way, conversations involving similar groups of people are brought closer in textual space than conversations involving different groups of people thereby enabling more efficient processing. It should be noted that messages 204A and 204E within a given social group 208A can remain ordered chronologically.

The preprocessed messages 204A-204E can then be processed by the computational model 110 to identify a plurality of candidate topics 210A-210E for inclusion in a topic digest 214. Accordingly, the computational model 110 can be configured to rank and filter the candidate topics 210A-210E using user interaction data 216 and a threshold interaction frequency 218. In various examples, the user interaction data 216 records the user's interaction history with each of the candidate topics 210A-210E and can include interactions with previous iterations of topic digests, replying to email threads, and the like. As such, the threshold interaction frequency 218 can define a minimum level of active user participation over a given time period (e.g., five percent over the last week). Consequently, the final selection of topics 210B, 210A, and 210D for the topic digest are the user's most active topics in terms of interaction frequency (e.g., a top three). After ranking and filtering the topics 210A-210E, the computational model 110 can then sort each message 204A-204E of the message sequence 202 into the final selection of topics 210B, 210A, and 210D to compile the topic digest 214.

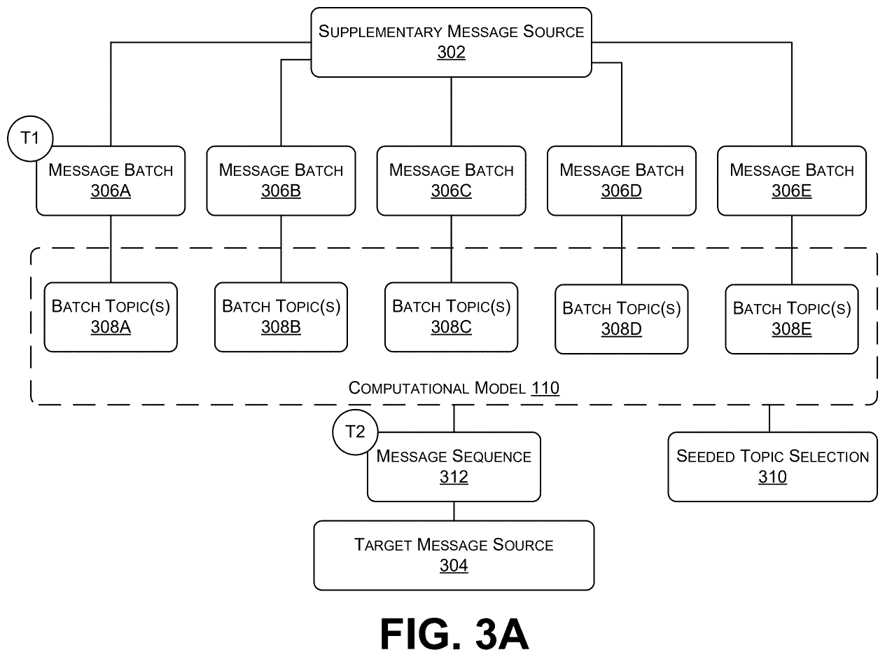

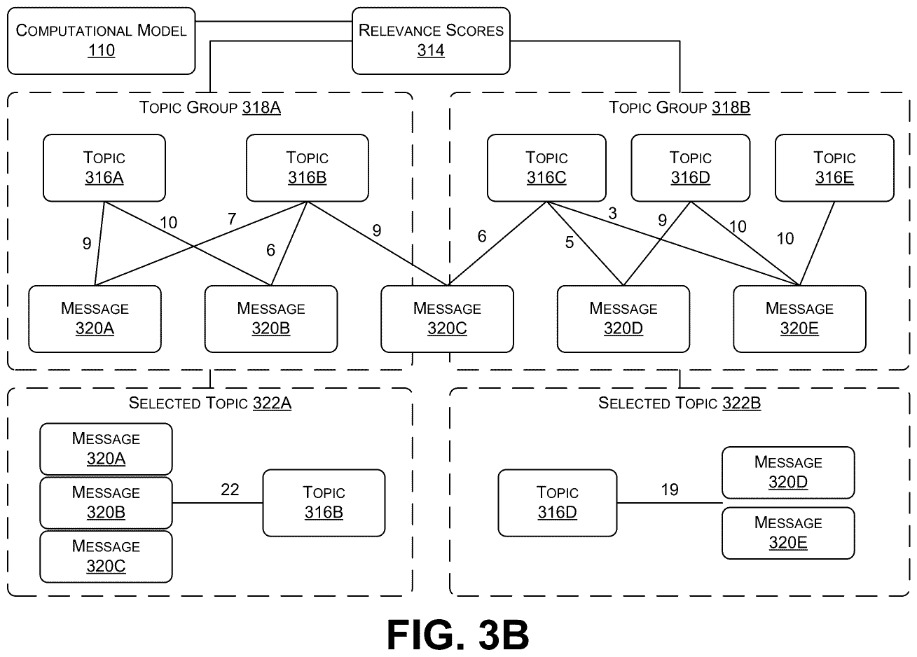

Proceeding to FIG. 3A, aspects of a warm-up process for initializing a computational model 110 using a supplementary message source 302 are shown and described. As mentioned above, the first time the computational model 110 generates a topic digest, it may do so without prior knowledge of the user's preferences and/or tendencies. That is, there may not be available data to bias the computational model 110 to provide a customized user experience. However, in some scenarios, the system may utilize a supplementary message source 302 that is (1) different from the target message source 306 and (2) provides a clear indication of the user's preferences and/or tendencies (e.g., a high signal-to-noise ratio). For instance, where an inbox may be the target message source, the supplementary message source 302 can be a “Sent Items” folder containing messages that the user has sent. Stated another way, messages that the user has previously sent provides an unambiguous insight into the topics that the user is actively engaged in. Moreover, extracting a sufficiently large number of sent messages provides further clarity by extending the window of analysis back in time (e.g., the past one hundred messages).

To enable efficient processing by the computational model 110, messages from the supplementary message source 302 can be partitioned at a first timeframe T1 into message batches 306A-306E. For example, if the system extracts one hundred messages from the supplementary message source 302, each message 306A-306E can comprise twenty messages. Accordingly, the computational model 110 can be configured to independently analyze the semantic content of each message batch 306A-306E to determine a corresponding set of batch topics 308A-308E similar to the examples described above with respect to FIG. 2. The batch topics 308A-308E can then be compiled, ranked, and filtered as discussed above to generate a seeded topic selection 310.

Subsequently, at a second timeframe T2, the computational model 110 be invoked to process a message sequence 312 from the target message source 304 (e.g., an inbox). Accordingly, the seeded topic selection 310 can then be utilized as part of an initialization input to the computational model 110 to initialize relevance scavenging when sorting messages into topics. By utilizing the relatively low-noise supplementary message source 302 to “warm-up” the computational model 110, the computational model 110 can form a preliminary user profile to seed message sorting (e.g., scavenging) on the comparatively noisier target message source 304. In this way, the computational model can provide customized topic digests even in the absence of prior knowledge regarding the user's preferences and/or tendencies.

Turning now to FIG. 3B, aspects of a topic relevancy competition for sorting messages into topics of a topic digest are shown and described. As mentioned above, the selection of topics for a topic digest can be determined by ranking and filtering a plurality of candidate topics. Subsequently, individual messages of a sequence of messages are sorted into the selection of topics. In one example, a computational model 110 accomplishes this by calculating relevance scores 314 quantifying a numerical relevance of each message of a given message sequence with respect to each topic. In this example, the semantic connection between a topic and a message is known as a citation.

However, due to the complexity of natural language and the inherent qualities of generative models (e.g., the computational model 110), the text content of a given message can have valid citations from multiple topics. In a simple example, the text “Bengal tiger” falls under the categories of “feline,” “mammal,” “animal” and “non-random string of bytes.” To resolve overlaps, the system places topics 316A-316E that share a threshold number of citations (e.g., at least two thirds of a total number of citations for a first topic are shared with a second topic) within a topic group 318A and 318B, respectively. As illustrated, lines connecting a given topic 316A to a given message 320A indicate a citations with the numerical label indicating the relevance score 314 for that particular citation. For instance, the relevance score 314 for the message 320A for the topic 316A is nine. Accordingly, the system linearly sums the relevance scores 314 for each topic 316A-316E and the topic 316A-316E with the greatest sum of relevance scores 314 in each topic group 318A and 318B is the selected topic 322A or 322B for the respective topic group 318A or 318B.

For example, consider the topic 316B which has citations to three messages 320A, 320B, and 320C. The sum of the relevance scores 314 for the three messages 320A, 320B, and 320C is “22” which is greater than the “19” of the topic 316A. Accordingly, the topic 316B is the selected topic 322A of the first topic group 318A and the messages 320A, 320B, and 320C are sorted into the topic 316B in the resulting topic digest. Likewise, the sum of relevance scores 314 for the topic 316D (“19”) is the greatest among the topics 316C-316E within the topic group 318B. Consequently, the topic 316D is the selected topic 322B for the topic group 318B and messages 320D and 320E are sorted into the topic 316D for the topic digest. In this way, the system can (1) reasonably resolve overlapping message citations across multiple topics and (2) cover every message 320A-320E of a given message sequence even when a message 320C semantically spans multiple valid topics and/or topic groups. That is, the user will not miss any messages if they choose to interact only within the topic digest interface. It should be understood that the linear sum of relevance scores for resolving the topic relevancy competition is merely an example and that any suitable scheme can be utilized such as an exponential weighting or a physics-based weighting.

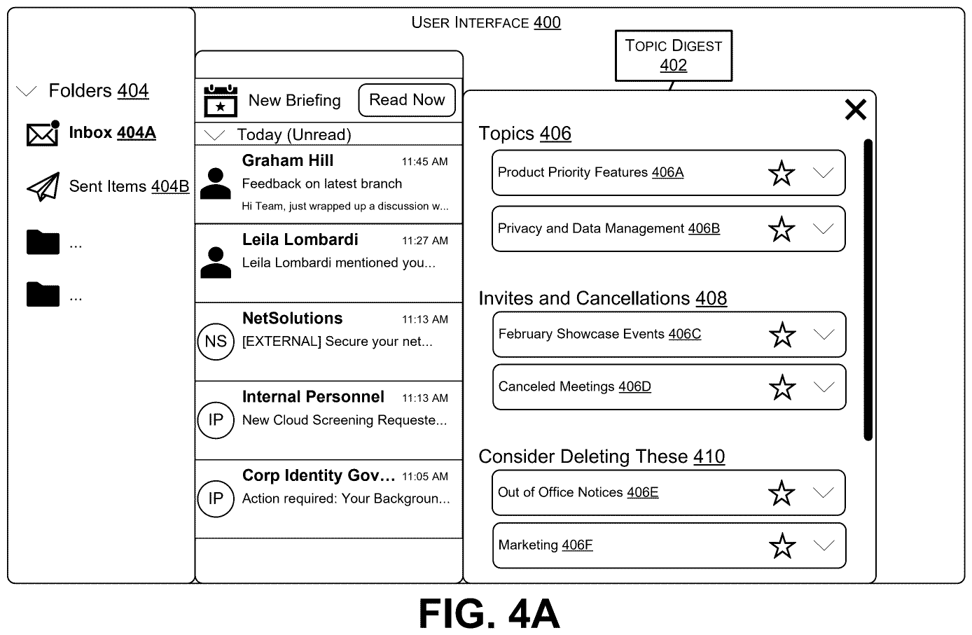

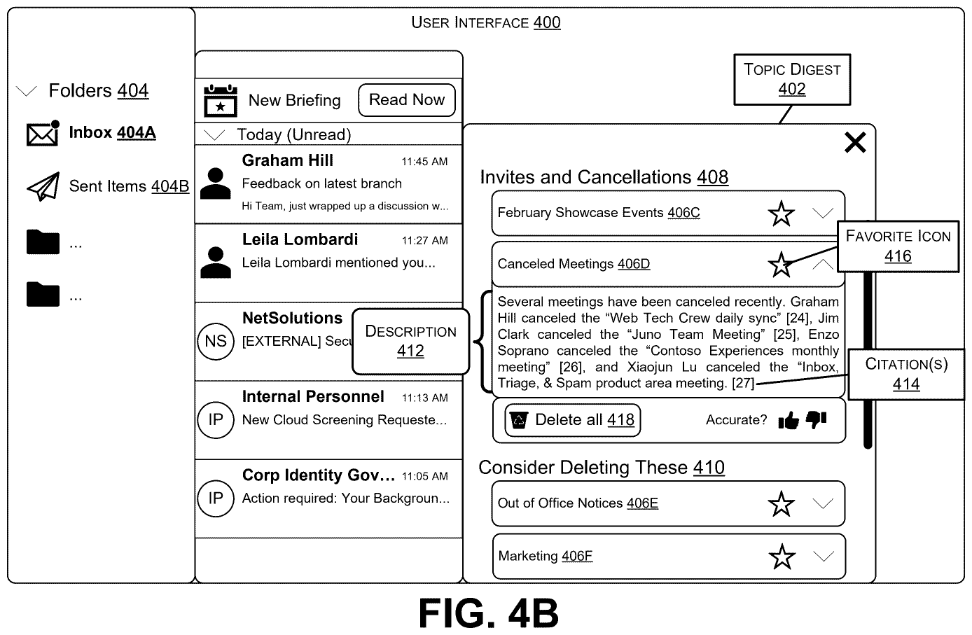

Turning now to FIG. 4A, aspects of an example user interface 400 for viewing and/or interacting with a topic digest 402 are shown and described. As shown, the user interface 400 displays a messaging software application (e.g., an email client) comprising a plurality of folders 404 such as an “Inbox” folder 404A and a “Sent Items” folder 404B. In the example of FIG. 4A, the “Inbox” folder 404A can be the target message source while the “Sent Items” folder 404B can be a supplementary message source as described above with respect to FIG. 3A. As shown, the “Inbox” folder 404A includes a plurality of unread messages originating from various senders (e.g., Graham Hill, Leila Lombardi, NetSolutions) and each containing different semantic content relating to various topics. In various examples, the unread messages in the “Inbox” folder 404A can be ordered with respect to time as shown by the timestamps included in each message (e.g., “11:45 AM”). Moreover, it should be understood that the illustrated messages are merely an example and that the “Inbox” folder 404A can contain any number of messages to be processed and/or summarized in a topic digest 402.

Accordingly, the unread messages can be compiled into a topic digest 402 that sorts the sequence of messages into a plurality of topics 406 such as a “Product Priority Features” topic 406A and a “Privacy and Data Management” topic 406B. Moreover, the topic digest 402 can be organized into additional categories such as an “Invites and Cancellations” category 408 relating to scheduling events and a “Consider Deleting These” category 410 relating to messages that the user has typically deleted without further interaction. For instance, the “Invites and Cancellations” category 408 includes a “February Showcase Events” topic 406C and a “Canceled Meetings” topic 406D. In addition, the “Consider Deleting These” category 410 includes an “Out of Office Notices” topic 406E and a “Marketing” topic 406F.

As mentioned above, the granularity of the topics 406 can be gradually customized to an individual user's preferences and/or tendencies based on both implicit and explicit user inputs from interactions with previous iterations of the topic digest 402. That is, successive iterations of the topic digest 402 act as latent variables for predicting user interactions, and the universe of known topics per action is refined with continued user interaction. For example, the system may determine that the user spends much of their time actively engaged in messages relating to their technical work as a software engineer. In response, topics relating to technical work can be presented in the topic digest with finer granularity (e.g., greater specificity) such as the “Product Priority Features” topic 406A and the “Privacy and Data Management” topic 406B.

Conversely, some topics may not require a fine granularity to be useful to the user. For example, finely classifying the “Canceled Meetings” topic 406D and/or the “Out of Office Notices” topic 406E may not be useful to the user if these topics are often bulk deleted and/or go unread. Moreover, as the system accumulates user interactions, the association between topics and actions can become reinforced over time. Consequently, the system can output the topic of the suggested action instead of or in conjunction with the original topics. For example, the system may determine that the user tends to bulk delete marketing messages without opening or otherwise interacting with them. That is, the user demonstrates an association between an action (e.g., bulk deletion) initiated by their interaction with the present iteration of the topic digest 402 and the “Marketing” topic 406F. In response, the system can sort such messages into the “Marketing” topic 406F and accordingly display the action associated with the “Marketing” topic 406F by presenting the “Marketing” topic 406F in conjunction with the “Consider Deleting These” category 410. In this way, the topic digest 402 aligns the various topics 406 to the user's specific needs and/or tendencies. As such, if the alignment is useful, the user is likely to maintain the topic/action linkage thereby continuing the cycle of self-reinforcement.

Proceeding to FIG. 4B, additional details of the user interface 400 of the messaging software application are shown and described. In this example, the user has expanded the “Canceled Meetings” topic 406D. As shown, the expanded “Canceled Meetings” topic 406D includes a description 412 comprising a natural language summary of the messages within the “Canceled Meetings” topic 406D. In addition, the description 412 can include citations 414 to individual messages using a message identification number as illustrated by the numbered square brackets (e.g., [24]). Accordingly, the user can select (e.g., click, tap) the citations 414 to view individual messages. In this way, the citations 414 serve to ground the description 412 in factual reality using supporting evidence thereby providing a trustworthy description 412.

In addition, the expanded “Canceled Meetings” topic 406D can include mechanisms for the user to provide both implicit and explicit user feedback. In one example, the user can select a favorite icon 416 to explicitly demonstrate their interest in the expanded “Canceled Meetings” topic 406D. In response, the system can prioritize inclusion of the expanded “Canceled Meetings” topic 406D in subsequent iterations of the topic digest 402, adjust the granularity of the topic, and other such customizations. Conversely, the user may select a “Delete all” element 418 to delete all of the messages within the expanded “Canceled Meetings” topic 406D without opening any of the citations 414. In this way, the user implicitly demonstrates that they are not interested in the individual messages and/or that the description 412 provided sufficient information for the user to catch up on the messages sorted into the “Canceled Meetings” topic 406D. By collecting both implicit and explicit user feedback within the topic digest 402, the system can iteratively customize the topic selection and sorting of messages to suit the user's specific needs and/or behaviors thereby providing an effortlessly customizable user experience.

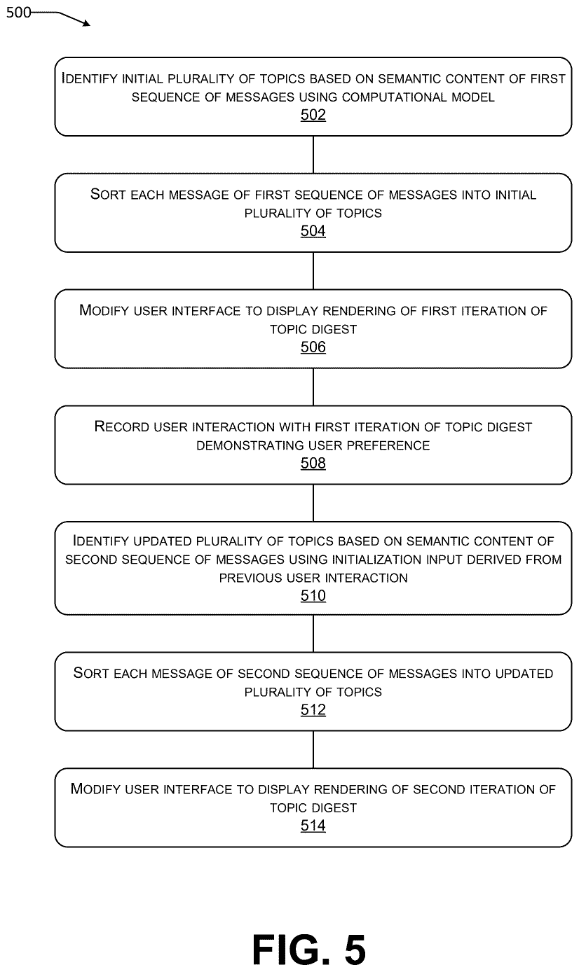

Turning now to FIG. 5, aspects of a process 500 for aligning topic digests of a sequence of messages to an individual user are shown and described. With respect to FIG. 5, the process 500 begins at operation 502 in which a topic digest system initiates generation of a first iteration of a topic digest during a first timeframe by identifying, via a first execution of a computational model, an initial plurality of topics from a first sequence of messages based on a semantic of the first sequence of messages. As discussed above, the first iteration of a topic digest may be generated without prior knowledge of the user's preferences and/or tendencies. Accordingly, the first iteration of the topic digest can be an unbiased topic digest. Moreover, the computational model can be a generative model such as a language model (e.g., a large language model, a small language model, a multimodal language model).

Then, at operation 504 the system, by the first execution of a computational model, sorts each message of the first sequence of messages into the initial plurality of topics. Referred to above as scavenging, the computational model matches individual messages to individual topics based on semantic relevance. Moreover, some messages may have valid matches to multiple topics leading to overlap which can be resolved using a relevancy competition.

Next, at operation 506, the system modifies a user interface of a messaging software application to display a rendering of the first iteration of the topic digest presenting the first sequence of messages sorted into the initial plurality of topics. As illustrated in FIGS. 4A and 4B, the rendering of the topic digest can be configured such that a user can view individual messages while viewing and/or interacting with the topic digest.

Subsequently, at operation 508, the system records a user interaction with the rendering of the first iteration of the topic digest within the user interface, wherein the user interaction demonstrates a user preference with respect to one or more topics of the initial plurality of topics. In various examples, the user interaction can be an implicit user input or an explicit user input. For instance, the user may bulk delete the messages of a given topic without reading and/or otherwise interacting with the topic. In this way, the action of bulk deletion is an implicit indication that the user does not care about and/or wish to see messages relating to the given topic.

Next, at operation 510, during a second timeframe the system initiates generation of a second iteration of the topic digest by identifying, via a second execution of the computational model, an updated plurality of topics from a second sequence of messages. However, in contrast to the first iteration, the computational model is configured with an initialization input that is derived from the recorded user interaction with one or more previous iterations of the topic digest. In this way, the initialization input biases the computational model towards the user's preferences demonstrated by the recorded interactions to gradually customize the topic digest.

Then, at operation 512, the computational model sorts each message of the second sequence of messages into the updated plurality of topics. Similar to the first iteration of the topic digest, sorting the second sequence of messages into the updated plurality of topics can be accomplished using a scavenging approach in which messages are greedily matched to topics such that every message is included in the topic digest.

Finally, at operation 514, the system modifies the user interface to display a rendering of the second iteration of the topic digest presenting the second sequence of messages sorted into the updated plurality of topics. In this way, the system forms a feedback loop in which user interactions accumulate over successive iterations of the topic digest to form a well-defined profile of the user's preferences and/or tendencies with which the system can provide gradually more customized topic digests.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

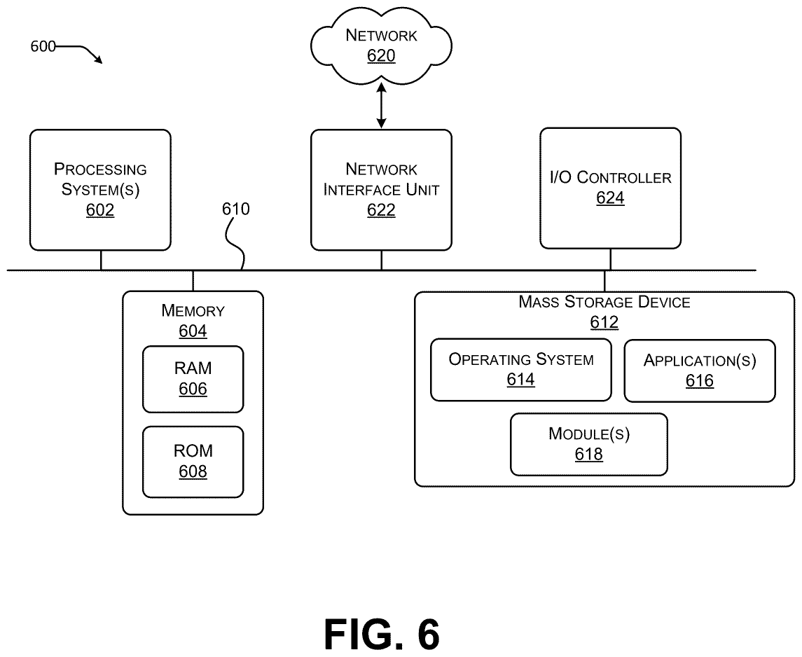

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of a volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.
Example Clause A, a method for aligning successive iterations of a topic digest to an individual user's preferences in a messaging software application, the method comprising: generating, during a first timeframe, a first iteration of the topic digest by: identifying, by a first execution of a computational model, an initial plurality of topics from a first sequence of messages based on a semantic content of the first sequence of messages; sorting, by the first execution of the computational model, each message of the first sequence of messages into the initial plurality of topics; and modifying a user interface of the messaging software application to display a rendering of the first iteration of the topic digest presenting the first sequence of messages sorted into the initial plurality of topics; recording a user interaction with the first iteration of the topic digest in the user interface of the messaging software application, wherein the user interaction demonstrates a user preference with respect to one or more topics of the initial plurality of topics; generating, during a second timeframe, a second iteration of the topic digest by: identifying, by a second execution of the computational model, an updated plurality of topics from a second sequence of messages utilizing an initialization input derived from the user interaction with the first iteration of the topic digest and based on a semantic content of the second sequence of messages; sorting, by the second execution of the computational model, each message of the second sequence of messages into the updated plurality of topics; and modifying the user interface of the messaging software application to display a rendering of the second iteration of the topic digest presenting the second sequence of messages sorted into the updated plurality of topics.
Example Clause B, the method of Example Clause A, wherein the user interaction with the first iteration of the topic digest is one of an implicit user input or an explicit user input.
Example Clause C, The method of Example Clause B, wherein generating the second iteration of the topic digest further comprises: identifying, by the computational model, an association between an action initiated by the user interaction with the first iteration of the topic digest and a topic of the initial plurality of topics; and displaying the action in conjunction with the topic in the rendering of the second iteration of the topic digest.
Example Clause D, the method of any one of Example Clause A though C, wherein the second sequence of messages is preprocessed prior to generating the second iteration by forming social groups within the second sequence of messages based on a sender and a receiver of each message of the second sequence of messages.
Example Clause E, the method of any one of Example Clause A though D, wherein the updated plurality of topics is ranked based on a frequency of user interaction with each topic of the updated plurality of topics derived from the user interaction with the first iteration of the topic digest.
Example Clause F, the method of any one of Example Clause A though E, wherein the updated plurality of topics is selected based on a threshold frequency of user interaction.
Example Clause G, the method of any one of Example Clause A though F, wherein sorting each message of the second sequence of messages into the updated plurality of topics includes a topic relevancy competition based on a numerical relevance of each message to each of the updated plurality of topics.
Example Clause H, the method of any one of Example Clause A though G, wherein the computational model is initialized prior to generating the first iteration of the topic digest utilizing a supplemental message source that is different from the first sequence of messages and the second sequence of messages.
Example Clause I, the method of any one of Example Clause A though H, wherein each of the updated plurality of topics presented in the rendering of the second iteration of the topic digest include citations to individual messages.
Example Clause J, a system for aligning successive iterations of a topic digest to an individual user's preferences in a messaging software application, the system comprising: a processing unit; a computer-readable medium having encoded thereon computer-readable instructions that, when executed by the processing unit, cause the system to perform operations comprising: generating, during a first timeframe, a first iteration of the topic digest by: identifying, by a first execution of a computational model, an initial plurality of topics from a first sequence of messages based on a semantic content of the first sequence of messages; sorting, by the first execution of the computational model, each message of the first sequence of messages into the initial plurality of topics; and modifying a user interface of the messaging software application to display a rendering of the first iteration of the topic digest presenting the first sequence of messages sorted into the initial plurality of topics; recording a user interaction with the first iteration of the topic digest in the user interface of the messaging software application, wherein the user interaction demonstrates a user preference with respect to one or more topics of the initial plurality of topics; generating, during a second timeframe, a second iteration of the topic digest by: identifying, by a second execution of the computational model, an updated plurality of topics from a second sequence of messages utilizing an initialization input derived from the user interaction with the first iteration of the topic digest; sorting, by the second execution of the computational model, each message of the second sequence of messages into the updated plurality of topics; and modifying the user interface of the messaging software application to display a rendering of the second iteration of the topic digest presenting the second sequence of messages sorted into the updated plurality of topics.
Example Clause K, the system of Example Clause J, wherein the user interaction with the first iteration of the topic digest is one of an implicit user input or an explicit user input.
Example Clause L, the system of Example Clause K, wherein generating the second iteration of the topic digest further comprises: identifying, by the computational model, an association between an action initiated by the user interaction with the first iteration of the topic digest and a topic of the initial plurality of topics; and displaying the action in conjunction with the topic in the rendering of the second iteration of the topic digest.
Example Clause M, the system of any one of Example Clause J through L, wherein the second sequence of messages is preprocessed prior to generating the second iteration by forming social groupings within the second sequence of messages based on a sender and a receiver of each message of the second sequence of messages.
Example Clause N, the system of any one of Example Clause J through M, wherein the updated plurality of topics is ranked based on a frequency of user interaction with each topic of the updated plurality of topics derived from the user interaction with the first iteration of the topic digest.
Example Clause O, the system of any one of Example Clause J through N, wherein the updated plurality of topics is selected based on a threshold frequency of user interaction.
Example Clause P, the system of any one of Example Clause J through O, wherein sorting each message of the second sequence of messages into the updated plurality of topics includes a topic relevancy competition based on a numerical relevance of each message to each of the updated plurality of topics.
Example Clause Q, the system of any one of Example Clause J through P, wherein the computational model is initialized prior to generating the first iteration of the topic digest utilizing a supplemental message source that is different from the first sequence of messages and the second sequence of messages.
Example Clause R, the system of any one of Example Clause J through Q, wherein each of the updated plurality of topics presented in the rendering of the second iteration of the topic digest include citations to individual messages.
Example Clause S, a computer-readable storage medium for aligning successive iterations of a topic digest to an individual user's preferences in a messaging software application, the computer-readable storage medium having encoded thereon computer-readable instructions that, when executed by a system, cause the system to perform operations comprising: generating, during a first timeframe, a first iteration of the topic digest by: identifying, by a first execution of a computational model, an initial plurality of topics from a first sequence of messages based on a semantic content of the first sequence of messages; sorting, by the first execution of the computational model, each message of the first sequence of messages into the initial plurality of topics; and modifying a user interface of the messaging software application to display a rendering of the first iteration of the topic digest presenting the first sequence of messages sorted into the initial plurality of topics; recording a user interaction with the first iteration of the topic digest in the user interface of the messaging software application, wherein the user interaction demonstrates a user preference with respect to one or more topics of the initial plurality of topics; generating, during a second timeframe, a second iteration of the topic digest by: identifying, by a second execution of the computational model, an updated plurality of topics from a second sequence of messages utilizing an initialization input derived from the user interaction with the first iteration of the topic digest; sorting, by the second execution of the computational model, each message of the second sequence of messages into the updated plurality of topics; and modifying the user interface of the messaging software application to display a rendering of the second iteration of the topic digest presenting the second sequence of messages sorted into the updated plurality of topics.
Example Clause T, the computer-readable medium of Example Clause S, wherein the user interaction with the first iteration of the topic digest is one of an implicit user input or an explicit user input.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for aligning successive iterations of a topic digest to an individual user's preferences in a messaging software application, the method comprising:
generating, during a first timeframe, a first iteration of the topic digest by:
identifying, by a first execution of a computational model, an initial plurality of topics from a first sequence of messages based on a semantic content of the first sequence of messages;
sorting, by the first execution of the computational model, each message of the first sequence of messages into the initial plurality of topics; and
modifying a user interface of the messaging software application to display a rendering of the first iteration of the topic digest presenting the first sequence of messages sorted into the initial plurality of topics;
recording a user interaction with the first iteration of the topic digest in the user interface of the messaging software application, wherein the user interaction demonstrates a user preference with respect to one or more topics of the initial plurality of topics;
generating, during a second timeframe, a second iteration of the topic digest by:
identifying, by a second execution of the computational model, an updated plurality of topics from a second sequence of messages utilizing an initialization input derived from the user interaction with the first iteration of the topic digest and based on a semantic content of the second sequence of messages;
sorting, by the second execution of the computational model, each message of the second sequence of messages into the updated plurality of topics; and
modifying the user interface of the messaging software application to display a rendering of the second iteration of the topic digest presenting the second sequence of messages sorted into the updated plurality of topics.

2. The method of claim 1, wherein the user interaction with the first iteration of the topic digest is one of an implicit user input or an explicit user input.

3. The method of claim 2, wherein generating the second iteration of the topic digest further comprises:
identifying, by the computational model, an association between an action initiated by the user interaction with the first iteration of the topic digest and a topic of the initial plurality of topics; and
displaying the action in conjunction with the topic in the rendering of the second iteration of the topic digest.

4. The method of claim 1, wherein the second sequence of messages is preprocessed prior to generating the second iteration by forming social groups within the second sequence of messages based on a sender and a receiver of each message of the second sequence of messages.

5. The method of claim 1, wherein the updated plurality of topics is ranked based on a frequency of user interaction with each topic of the updated plurality of topics derived from the user interaction with the first iteration of the topic digest.

6. The method of claim 1, wherein the updated plurality of topics is selected based on a threshold frequency of user interaction.

7. The method of claim 1, wherein sorting each message of the second sequence of messages into the updated plurality of topics includes a topic relevancy competition based on a numerical relevance of each message to each of the updated plurality of topics.

8. The method of claim 1, wherein the computational model is initialized prior to generating the first iteration of the topic digest utilizing a supplemental message source that is different from the first sequence of messages and the second sequence of messages.

9. The method of claim 1, wherein each of the updated plurality of topics presented in the rendering of the second iteration of the topic digest include citations to individual messages.

10. A system for aligning successive iterations of a topic digest to an individual user's preferences in a messaging software application, the system comprising:
a processing unit;
a computer-readable medium having encoded thereon computer-readable instructions that, when executed by the processing unit, cause the system to perform operations comprising:
generating, during a first timeframe, a first iteration of the topic digest by:
identifying, by a first execution of a computational model, an initial plurality of topics from a first sequence of messages based on a semantic content of the first sequence of messages;
sorting, by the first execution of the computational model, each message of the first sequence of messages into the initial plurality of topics; and
modifying a user interface of the messaging software application to display a rendering of the first iteration of the topic digest presenting the first sequence of messages sorted into the initial plurality of topics;
recording a user interaction with the first iteration of the topic digest in the user interface of the messaging software application, wherein the user interaction demonstrates a user preference with respect to one or more topics of the initial plurality of topics;
generating, during a second timeframe, a second iteration of the topic digest by:
identifying, by a second execution of the computational model, an updated plurality of topics from a second sequence of messages utilizing an initialization input derived from the user interaction with the first iteration of the topic digest;
sorting, by the second execution of the computational model, each message of the second sequence of messages into the updated plurality of topics; and
modifying the user interface of the messaging software application to display a rendering of the second iteration of the topic digest presenting the second sequence of messages sorted into the updated plurality of topics.

11. The system of claim 10, wherein the user interaction with the first iteration of the topic digest is one of an implicit user input or an explicit user input.

12. The system of claim 11, wherein generating the second iteration of the topic digest further comprises:
identifying, by the computational model, an association between an action initiated by the user interaction with the first iteration of the topic digest and a topic of the initial plurality of topics; and
displaying the action in conjunction with the topic in the rendering of the second iteration of the topic digest.

13. The system of claim 10, wherein the second sequence of messages is preprocessed prior to generating the second iteration by forming social groupings within the second sequence of messages based on a sender and a receiver of each message of the second sequence of messages.

14. The system of claim 10, wherein the updated plurality of topics is ranked based on a frequency of user interaction with each topic of the updated plurality of topics derived from the user interaction with the first iteration of the topic digest.

15. The system of claim 10, wherein the updated plurality of topics is selected based on a threshold frequency of user interaction.

16. The system of claim 10, wherein sorting each message of the second sequence of messages into the updated plurality of topics includes a topic relevancy competition based on a numerical relevance of each message to each of the updated plurality of topics.

17. The system of claim 10, wherein the computational model is initialized prior to generating the first iteration of the topic digest utilizing a supplemental message source that is different from the first sequence of messages and the second sequence of messages.

18. The system of claim 10, wherein each of the updated plurality of topics presented in the rendering of the second iteration of the topic digest include citations to individual messages.

19. A computer-readable storage medium for aligning successive iterations of a topic digest to an individual user's preferences in a messaging software application, the computer-readable storage medium having encoded thereon computer-readable instructions that, when executed by a system, cause the system to perform operations comprising:
generating, during a first timeframe, a first iteration of the topic digest by:
identifying, by a first execution of a computational model, an initial plurality of topics from a first sequence of messages based on a semantic content of the first sequence of messages;
sorting, by the first execution of the computational model, each message of the first sequence of messages into the initial plurality of topics; and
modifying a user interface of the messaging software application to display a rendering of the first iteration of the topic digest presenting the first sequence of messages sorted into the initial plurality of topics;
recording a user interaction with the first iteration of the topic digest in the user interface of the messaging software application, wherein the user interaction demonstrates a user preference with respect to one or more topics of the initial plurality of topics;
generating, during a second timeframe, a second iteration of the topic digest by:
identifying, by a second execution of the computational model, an updated plurality of topics from a second sequence of messages utilizing an initialization input derived from the user interaction with the first iteration of the topic digest;
sorting, by the second execution of the computational model, each message of the second sequence of messages into the updated plurality of topics; and
modifying the user interface of the messaging software application to display a rendering of the second iteration of the topic digest presenting the second sequence of messages sorted into the updated plurality of topics.

20. The computer-readable medium of claim 19, wherein the user interaction with the first iteration of the topic digest is one of an implicit user input or an explicit user input.
